(19) United States
(12) Patent Application Publication
(10) Pub. No.: US 2011/0229855 A1
(43) Pub. Date: Sep. 22, 2011

(54) DENTAL PROSTHESIS

(76) Inventor: Ameen Khraisat, Amman (JO)

(21) Appl. No.: 12/991,444

(22) PCT Filed: Apr. 10, 2009
(86) PCT No.: PCT/RU09/00174

§ 371 Date: Nov. 8, 2010

(30) Foreign Application Priority Data
Dec. 12, 2008 (RU) 2008149053

(51) Int. Cl. A61C 8/00

(52) U.S. Cl. 433/174

(57) ABSTRACT

A dental prosthesis has an abutment, a screw, and an implant, the bearing surface of which is embedded into bone tissue. A projection with a vertical thread hole for the screw connecting the implant with the abutment is positioned on the bearing surface of implant. The abutment has receptacle hole for the projection, and the implant supporting surface and lower thread of the screw connection are located above the bone tissue level.

### BACKGROUND OF THE INVENTION

1. Field of the Invention

The invention is related to the dentistry and is pertinent to dental prostheses having implant to be embedded into the jawbone.

2. Description of the Related Art

In all known dental implants the construction of implant-abutment connection is implemented either with internal extension of abutment into implant or with external extension of implant into abutment. In both types abutment and implant are connected with the screw, which passes through the center of abutment and is engaged by the threaded hole in the implant, wherein the screw of the threaded hole is positioned below the implant head level, as it is illustrated in FIG. 1. The denotations in the presented figure are as follows: screw 1 of Unigrip abutment, abutment 2, implant 3 (3.75×10-mm Mark III) and bone tissue 4. The length of the screwed in portion of the abutment screw is variable in different systems, and in some of them can reach the lower third part of the implant, while the typical implant length is 10 mm.

Diameter of the abutment screw is about 2.0 mm with the pitch of about 0.12 mm. In almost all systems regular implant diameter is 4.0 or 4.1 mm. However, the similar dimensions of the abutment screw are present in the smaller implants of 3.75 or 3.8 mm in diameter. The pitch of external thread of the implant is about 0.15mm. This means that implant diameter without the implant screw pitch is about 3.5 mm.

Taking into account dimensions (diameter) of the abutment screw, the diameter of thread hole in the implant should be at least, 2.1 mm. Consequently, the implant thickness around the abutment screw is about 0.6 mm, and the implant length from the bearing surface of the implant to the bottom of the thread hole will be at least 5.0 mm, as it is illustrated in FIG. 2.

Any screw connecting two parts should be tightened with certain force, which puts strain the screw body and hence fastens the connected parts. In the event of implant-abutment screwing up this strain manifests itself in the body of the abutment screw during tightening, and will have effect, producing the back force, at the interface between abutment base and the bearing surface of the implant and at the interface of the abutment screw thread with the internal thread of implant (see. FIG. 2), where the strain in screw 1 and the back forces at the surfaces of abutment 2 and implant 3 at the surfaces in contact with the screw are shown by the arrows.

Counteracting forces produce strain in the bodies of abutment 2 and implant 3. This strain is transferred to the external surface of the implant, especially if thin sections are present in its upper part. Furthermore, as far as there is continuous strain in the screw (though it can vary with time due to micromotions in the course of the use of the dental prosthesis, relief of tightening, and metal fatigue), it produces continuous transfer of the strain on the external surface of implant even in static situation, i.e. without external load on the implant construction.

The presence of the strain in the implant projection (implant collar deformity) has an effect on the marginal bone tissue. This results in fast loss of the marginal bone tissue before the functioning stage (before prosthetic procedure) and to annual loss of the bone mass (for instance, annual loss of the bone mass up to 0.2 mm is considered acceptable) being the principal long-term problem is all systems of dental prosthesis.

Dental abutment with the screwed shank and crown is known. The crown is implemented directly on the abutment by applying three layers of the ceramic material: opaque, dentin, and enamel layers. The abutment surface is made roughened. (RU 2334487 OT 2007.04.25).

The disadvantages of this abutment are low reliability, high strain in the head portion of the implant, fast loss of the marginal bone tissue before the prosthetic procedure, and annual loss of the bone mass in the process of the prosthesis usage.

The closest analogue of the claimed invention is the abutment for the prosthesis with cement-screw retention, comprising threaded fixation hole implemented in up and down direction through the abutment body, and the receptacle portion for the connecting projection, which is farmed on the upper end of the implant. The receptacle portion has a groove for bonding, engaging with the upper end of the connecting projection, and groove with allowance providing for the allowance space, which enables to remove readily the connecting projection from the groove for bonding and to insert it into the groove for bonding. The groove with allowance is implemented with tilt from the bottom end of the groove for bonding forming inclined allowance space, providing the entry direction for the connecting projection (RF 2313308 of 11.03.2004, A61C 8/00).

The disadvantages of this prosthesis are the presence of the strain in the head portion of the implant, which affects the marginal bone. This results in fast loss of the marginal bone tissue even before the functioning stage (before prosthetic procedure), and annual loss of the bone mass; annual loss of the bone mass up to 0.2 mm is considered acceptable and is the major problem is all systems of dental prosthesis.

### SUMMARY OF THE INVENTION

Technical result of the advanced invention is the prevention of the marginal bone tissue loss before the prosthetic procedure and reduction or prevention of annual bone mass loss in the process of the prosthesis usage.

Said technical result is achieved by the use of dental prosthesis comprising abutment, screw, and implant with the bearing surface, which is embedded into the bone tissue. The projection with vertical central thread hole for the screw connecting implant with abutment is positioned on the bearing surface of implant. The abutment has receptacle hole for the projection, and the bottom end of the abutment rests on the implant bearing surface. The implant supporting surface and lower thread of the screw connection are located above the bone tissue level.

In some embodiments for better folding resistance the groove is made on the implant bearing surface along the perimeter of the projection, and on the bottom end of abutment corresponding projection complementary to the groove is made, with the bottom of the groove located above the bone tissue level.

In addition, the implant projection and corresponding hole in abutment may be cylindrical.

The cross-section of implant projection and corresponding hole in the abutment may be in the form of regular polygon.

To achieve more sound connection the implant projection and corresponding hole in the abutment may be in the cone form, such as Morse cone.

Thus, all stress conditions in the abutment-implant connection, which can produce the implant collar deformity and, hence, exert pressure on the marginal bone tissue, are repositioned above the bone tissue level.

### BRIEF DESCRIPTION OF THE DRAWINGS

FIG. 1 is a cross-section of a prior art implant and abutment in bone tissue.

FIG. 2. is a cross-section of a prior art implant and abutment.

FIG. 3 is a cross-section of implant/abutment connection according to the advanced invention with the implant projection.

FIG. 4 is a cross-section of implant/abutment connection according to the advanced invention with conical projection.

FIG. 5a is a cross-section of implant/abutment connection according to the advanced invention with the implant projection and with the groove in the bearing surface of the implant.

FIG. 5b is a cross-section of implant/abutment connection according to the advanced invention with conical implant projection above the bone level and with the groove in the bearing surface of the implant.

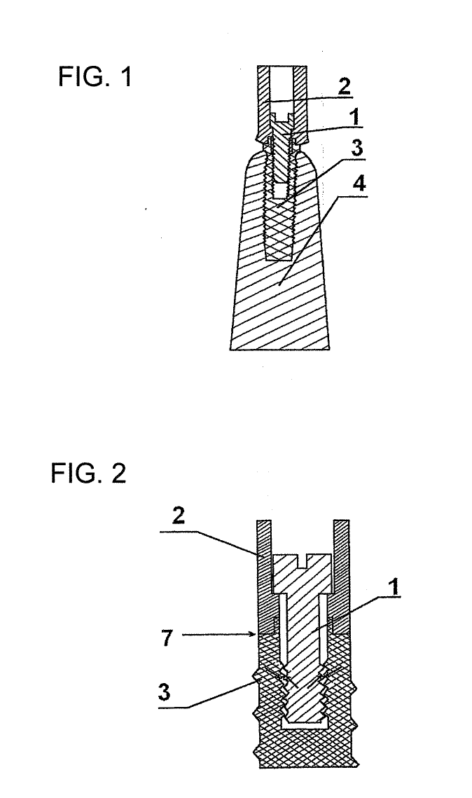

### DETAILED DESCRIPTION OF THE PREFERRED EMBODIMENTS

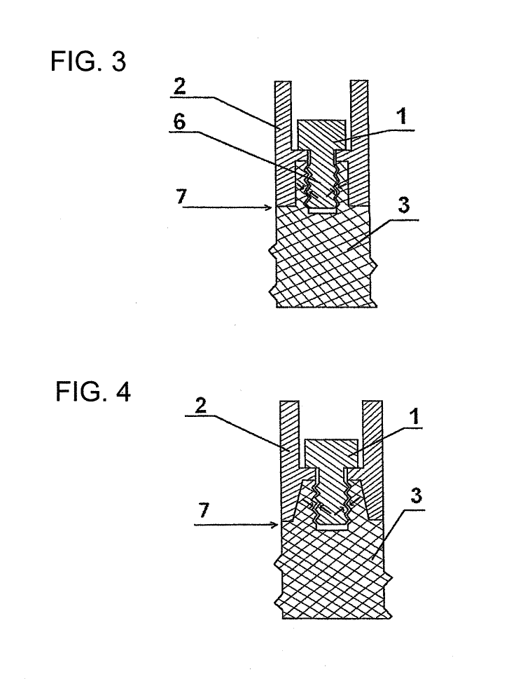

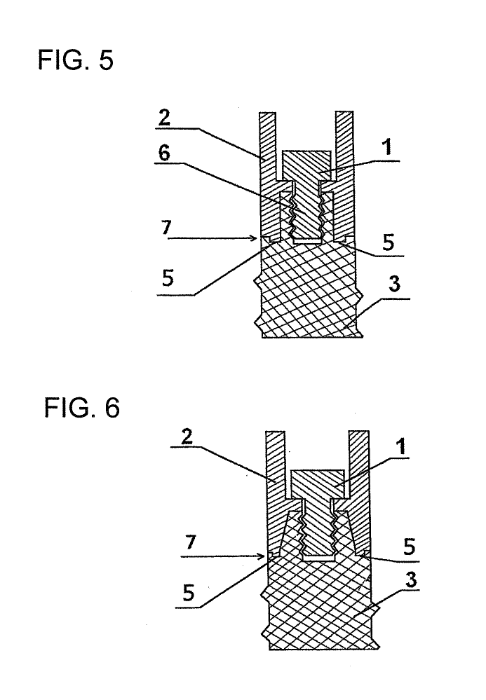

Dental prosthesis as shown in FIG. 3, FIG. 4, and FIG. 5, comprises implant 3 to be embedded into the bone tissue, said implant having bearing surface for the bottom end of abutment 2 and projection 6 with central vertical thread hole for screw 1, with the projection position on the bearing surface. Screw 1 connects implant with abutment. Abutment has receptacle hole for projection 6. Bottom end of the abutment coming in contact with the bearing surface of the implant and the lower thread of the screw connection are located above the bone tissue level 7. Optionally, on the bearing surface of the implant the groove 5 can be made with the bottom of the groove located not lower than the bone tissue level 7, and on the bottom end of the abutment corresponding projection complementary to the groove is made, as shown in FIG. 5a and FIG. 5b, to protect implant-abutment connection from the rotational forces.

Therefore, in the claimed dental prosthesis the last thread of the implant/abutment screw connection is raised above the bone tissue level 7. For this purpose the implant projection with the internal thread is raised above the bone tissue level. All stress conditions in the abutment-implant connection, which can produce the implant deformity and, hence, exert pressure on the marginal bone tissue, are repositioned above the bone tissue level (FIG. 3). The projection on the implant bearing surface may have cylindrical form or the cross-section of implant projection may have the form of regular polygon, such as pentagon or hexagon. In addition, the projection on the implant bearing surface may have the cone form, such as Morse cone for more sound connection.

In FIG. 3 and FIG. 4 the arrows show the directions of the stresses arising in implant-abutment connection. As is evident from the drawings, all stresses in the claimed dental prosthesis are located above the bone tissue level.

It was shown by the experiment that existing deformity in the upper part of the implant results in impact on the marginal bone tissues, and in the known dental prostheses said impact can reach considerable value of 60 MPa, while in the claimed dental prosthesis corresponding value is as low as 5 MPa.

Claimed dental prosthesis can be made with the use of known technologies based on the known materials. Advanced invention enables to prevent the loss of the marginal bone tissue before the prosthetic procedure and reduce or prevent annual loss of the bone in the process of the prosthesis usage.

1. Dental prosthesis comprising abutment, screw, and implant which is embedded into the bone tissue, said implant having bearing surface, on which the bottom end of the abutment rests, and on which the projection with central vertical thread hole for the screw connecting implant with abutment is positioned, with the abutment having receptacle hole for the projection, wherein the implant supporting surface and lower thread of the screw connection are located above the bone tissue level.

2. Dental prosthesis according to claim 1, wherein the groove is made on the implant bearing surface along the perimeter of the projection, and on the bottom end of abutment corresponding projection complementary to the groove is made, with the bottom of the groove located above the bone tissue level.

3. Dental prosthesis according to claim 1, wherein the implant projection and corresponding hole in abutment are made cylindrical.

4. Dental prosthesis according to claim 1, wherein the cross-section of implant projection and corresponding hole in the abutment have the form of regular polygon.

5. Dental prosthesis according to claim 1, wherein the implant projection and corresponding hole in the abutment have the cone form, such as Morse cone.
